(19) United States
(12) Patent Application Publication
(10) Pub. No.: US 2004/0133535 A1
(43) Pub. Date: Jul. 8, 2004

(54) Event positioning and detection system and methods

(75) Inventors: Peter Hans Scharler, Uniontown, PA (US); Jason Thomas Winters, Melbourne, FL (US)

Correspondence Address: GREENBERG-TRAURIG, 1750 TYSONS BOULEVARD, 12TH FLOOR, MCLEAN, VA, 22102, US

(73) Assignee: Tangent Research Corporation, Frederick, MD

(21) Appl. No.: 10/631,740

(22) Filed: Aug. 1, 2003

Related U.S. Application Data
(60) Provisional application No. 60/399,709, filed on Aug. 1, 2002.

(51) Int. Cl. G06G 7/62

(52) U.S. Cl. 706/928; 703/17

(57) ABSTRACT

Event positioning and detection system and methods which can determine an event epicenter based on tangential relationships between a plurality of sensors and the waveform created by the event as it occurs and is detected in a medium.

This application claims priority from Provisional U.S. Patent Application Serial No. 60/399,709, filed Aug. 1, 2002, which is hereby incorporated by reference in its entirety.

### FIELD OF THE INVENTION

The present invention relates to the field of event detection and position determination.

### BACKGROUND OF THE INVENTION

An event is an occurrence that causes a disturbance in the surrounding environment. For example, a hand clapping in a room is an acoustic event that causes sound waves to propagate throughout the air in the room. By positioning microphones (i.e. sensors capable of detecting the disturbances caused by the event) in the room, the position of a hand clapping event within the room can be determined through triangulation. Triangulation is well known in the art, and involves the measurement of the delay between event detection at one sensor and detection at at least two other sensors. If the position of each of the sensors is known, the event location can be determined based on the difference in the delay times and the separation of the sensors. U.S. Pat. No. 5,973,988, to Showen et al., describes the use of triangulation in a real-time gunshot locator and display system.

### SUMMARY OF THE INVENTION

The present invention is directed to a system and methods through which events can be detected and their position determined that substantially obviates one or more of the problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The present invention utilizes a new technique to determine the position of an event. The present invention preferably includes a sensor array, for sampling event information as data, and a computer or other processor for evaluating the data to determine the event origin. Over time, the present invention can track an event, and even allow a system to react to an event.

The events that the system can process are limited only by the type of sensors used for data collection. By way of example, without intending to limit the present invention, the system can process seismic, acoustic (in air, in water, or in other media), ultrasonic, radio frequency, and light events. Naturally occurring acoustic events which the present invention can process include earthquakes, thunder, and underwater cetacean vocalizations. The present invention can be applied to existing event detection systems to improve their accuracy, and can be used in a variety of new applications, including, but not limited to, the home theater and audio, automotive, security, and communication industries.

Features of the system include data collection and storage, real-time and post sampling analysis, filtering, two-dimensional and three-dimensional analysis, trending and modeling, error correction, and optimized algorithms to reduce the number of sensors deployed.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a flowchart indicating a preferred system organization.

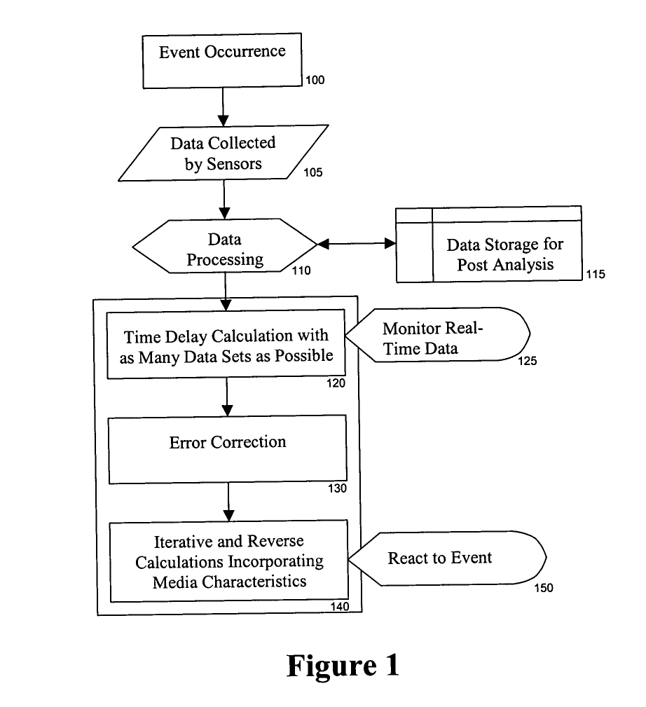

FIGS. 2a and 2b are block diagrams illustrating examples events occurring within a sensor array and outside a sensor array.

FIG. 3 is a block diagram illustrating sensor position as waves created by an event become incident to each sensor.

FIGS. 4a through 4c are block diagrams illustrating a means through which errors can be detected in a three sensor array.

FIG. 5 is an illustration of a prototype event processor that collects event data from sensors, determines an event epicenter, and tracks events to detect unauthorized entry into a room or underwater area.

FIG. 6 is an illustration of a prototype sensor array, comprised of condenser microphones used to pick acoustic events, which is capable of providing event data to the prototype event processor of FIG. 5.

FIG. 7 is a closer look at connectors and condenser microphones in the prototype sensor array of FIG. 6.

FIG. 8 is a chart of waveforms collected by the microphones in the sensor array of FIG. 6.

FIG. 9 is a screen capture of a graphical representation of event data collected by the prototype sensor array of FIG. 6 and processed by the prototype event processor of FIG. 5 illustrating event movement as an event travels in from the northeast.

FIG. 10 is block diagram illustrating a preferred home theater embodiment of the present invention in which movable or adjustable speakers are deployed, and wherein the “sweet spot” for the room is determined.

### DETAILED DESCRIPTION OF THE PREFERRED EMBODIMENT

Reference will now be made in detail to the preferred embodiments of the present invention, examples of which are illustrated in the accompanying drawings.

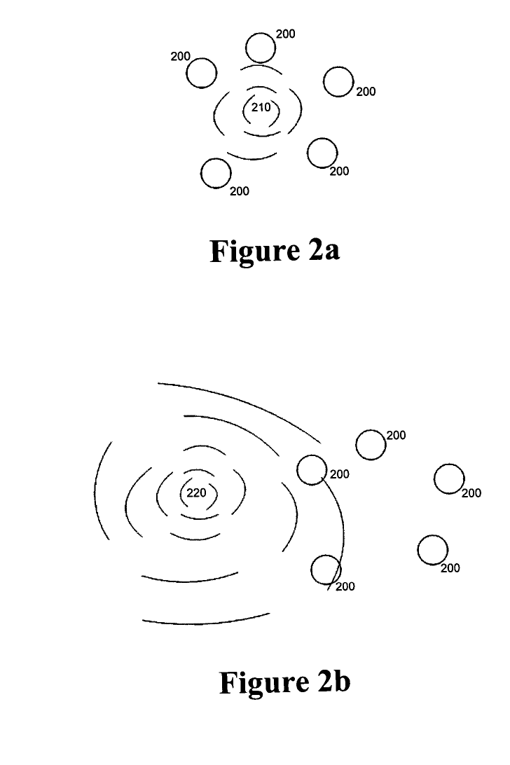

In a preferred embodiment of the present invention, disturbances created by an event are monitored through a grid of sensors, and the sensory information is communicated to a system designed to process such information. FIGS. 2a and 2b are block diagrams illustrating examples events occurring within a sensor array and outside a sensor array. Each sensor experiences the event information at different times, at different positions, and may receive different frequency responses. From the frequency, differences in time and position of sensors, the precise location and time of the event are determined. If the event is moving, then direction and orientation can also be determined.

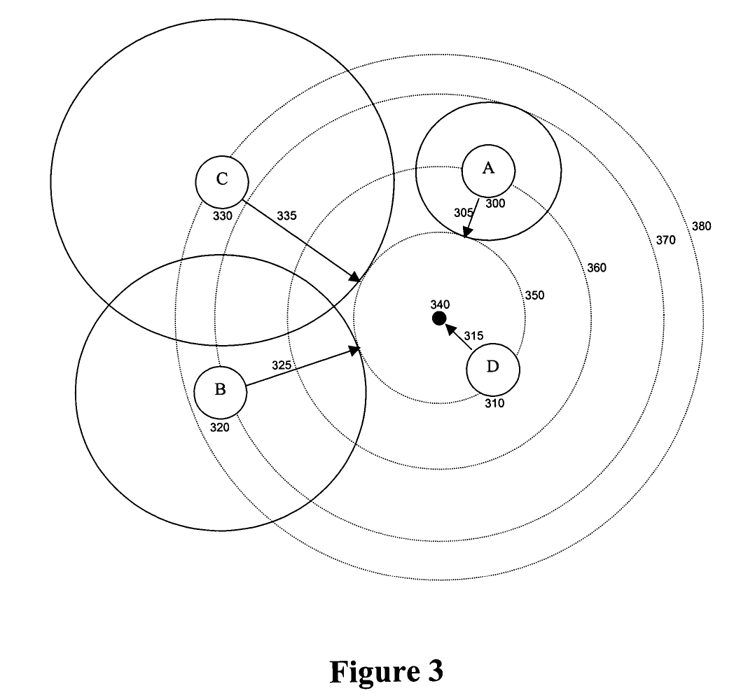

Each sensor experiences the event at different times and positions and frequency response by the sensors themselves. FIG. 3 is a block diagram illustrating sensor positions as waves created by an event become incident to each sensor.

As illustrated in FIG. 3 by concentric event waves 350, 360, 370, and 380, the sensors 300, 310, 320, and 330, experience an even at different times due to the difference in their positions. The differing sensor positions can also cause the sensors to detect the event with different frequency responses because, although the event waves propagate uniformly through a medium since the speed of sound and electromagnetic waves are constant, event waves passing through media may be subject to frequency and other distortions. Although FIG. 3 is a two-dimensional plot of a sensor array, it should be apparent to one skilled in the art that the system and methods of the present invention can be utilized in three dimensions as well.

The sensors can be deployed in a fixed array or any configuration, as long as the sensors know where they are relative to each other. The sensors can be deployed using wired or wireless communication. If coupled with a global positioning system receiver, each sensor can determine its own location, from which the processor can determine the relative sensor positions.

FIG. 3 is a detailed layout indicating sensor position as the waves created by the event become incident to each sensor. The location of the event can be determined by first recognizing that when event 340 occurs, the waves created therefrom will propagate in a circular manner in two dimensions, or spherical manner in three dimensions. In FIG. 3, wave 350 reaches sensor 310 some time after the event occurs. At some later point in time, wave 350 has grown to wave 360 and impacts sensor 300. Sensors 300 and 310 can determine the frequency of the incoming wave, and the speed of the wave can be determined based on average propagation speeds for waves created through the monitored event type as they pass through the medium in which the sensors are deployed. As each sensor detects an event, the time at which the event is first detected is precisely recorded. Given the speed of the waveform through the medium and the time delay between when sensor 310 experiences the event and when sensor 300 experiences the event, the length of line segment 305 can be determined. As waveform 360 continues to propagate and becomes waveform 370, it is detected by sensor 320. Using the technique described above, the length of line segment 325 can be determined. In the two dimensional illustration of FIG. 3, by combining the circle described by line segment 305 originating at sensor 300, the circle described by line segment 325 originating at sensor 320, and the fact that sensor 310 and each of the circles are tangential to the event origin, the precise location of the event, or epicenter of the event, can be determined.

Number of Sensors

The number of sensors required to find the precise epicenter or origin of an event is n+2, where n equals the number of dimensions that the results are required to indicate. For example, for three-dimensions, five sensors are required to give the most accurate information. However, the system attempts to calculate the results with any amount of sensor data sets that are collected.

Error Correction

If there are multiple systems and redundant sensors deployed, the system can error correct through modeling and probability. In a preferred embodiment, error correction works in the following manner:

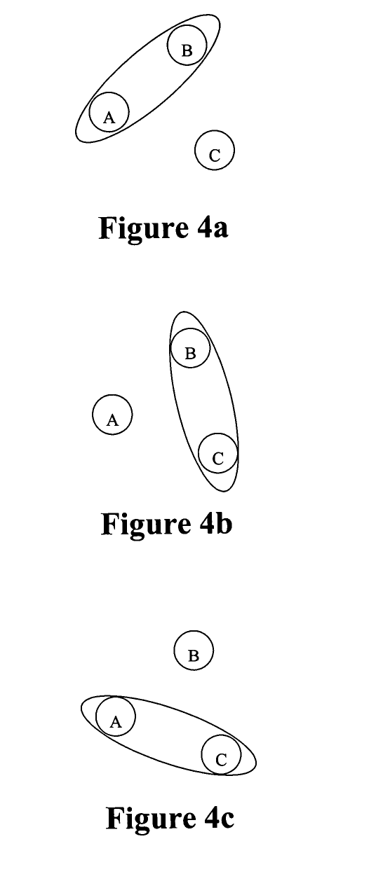

Assuming the algorithm needs only two data sets to find the origin of the event and the time of occurrence, and that there are three sensors available, if the sensors are labeled A, B, and C, as in FIG. 4, the system can process the data from A and B, B and C, and A and C. Each calculation set should produce similar results; however, if the results are different, this would indicate that a sensor was either bad or collecting erroneous data.

FIG. 4 runs through the 3 sensor example pictorially with additional narration.

Reverse Calculation

In addition to the grouping calculation method described above for error correction, once the results are calculated, the system can do the calculations in reverse, based on the predicted epicenter, to determine when each sensor should experience the event. Once a relative epicenter is calculated, the system can also take medium changes into account, since the exact path the wave disturbance traveled to the sensors can be determined. If the path involved earth, granite, water, or other materials, the indices of refraction, propagation speed, and other such information can be taken into account to allow for a more precise calculation.

System

As mentioned above, the system has several parts that allow for precise calculation of an event epicenter or origin and be able to react the information in real-time.

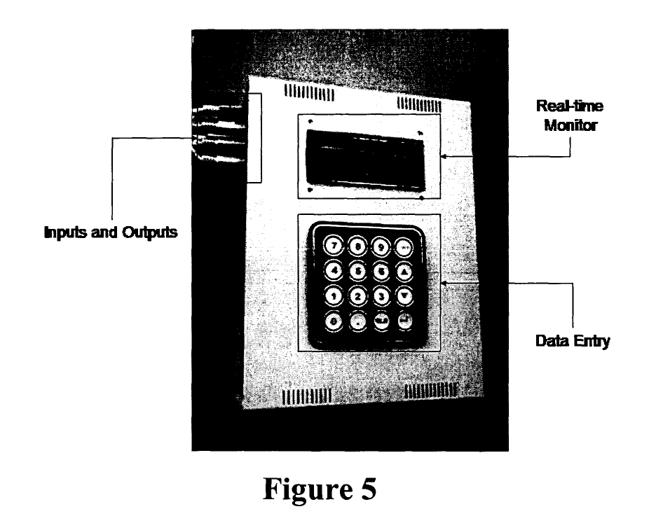

FIG. 5 shows a prototype system that collects event data from condenser microphones and determines the epicenter and tracks the information to detect unauthorized entry into a room or underwater area.

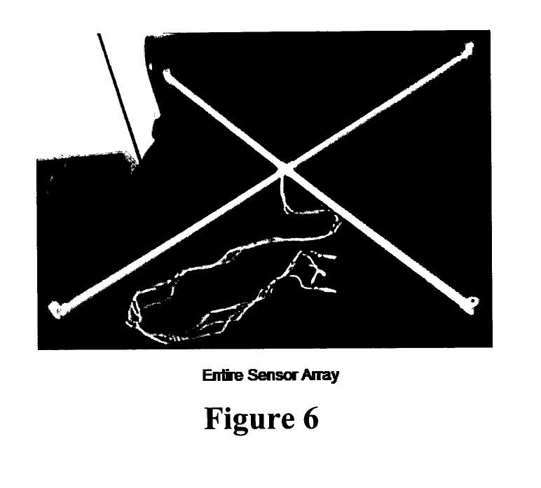

FIG. 6 shows the entire sensor array of condenser microphones used to pick acoustic events and send them to the system in FIG. 5.

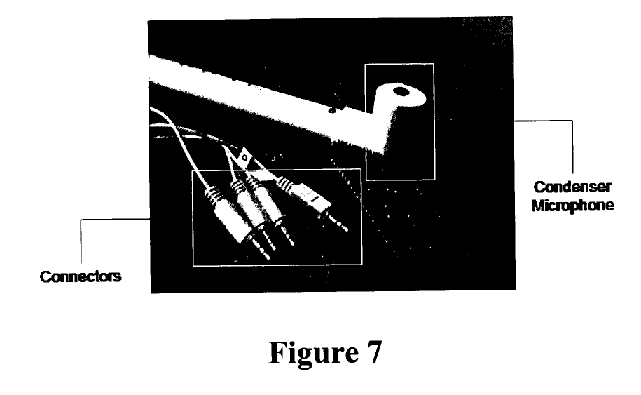

FIG. 7 is a closer look at the connectors and condenser microphones in the sensor array.

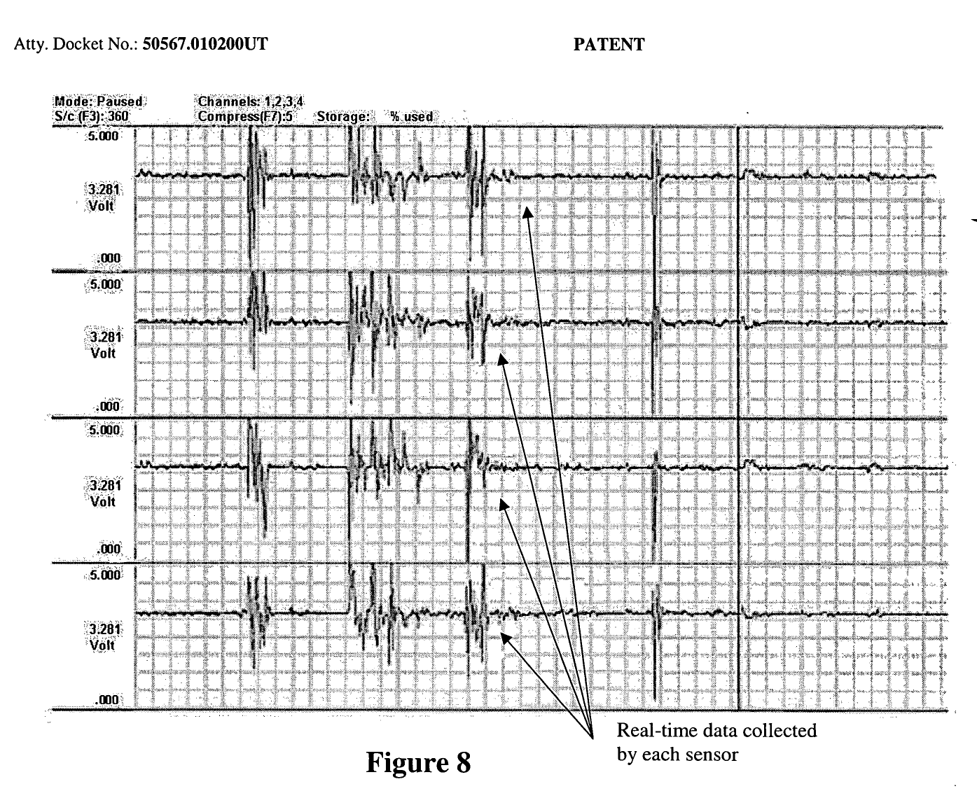

FIG. 8 is a chart of the waveforms collected by the four condenser microphones in the sensor array. This is the data collected and processed by the system.

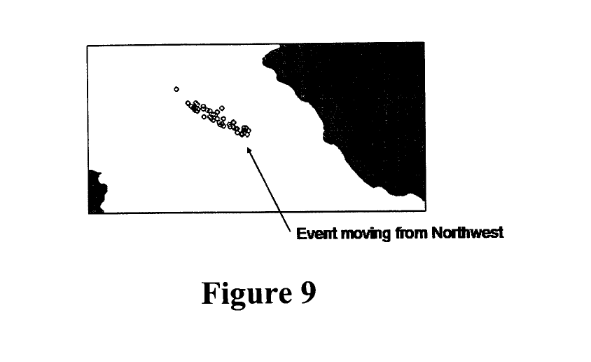

FIG. 9 is a screenshot from the system software as the system tracks an event occurring and moving in from the northeast. This mapping screen is monitored to reveal unauthorized entry into a space (above ground or underwater).

Home Theater System

One of the most comprehensive systems deployed to fully demonstrate all of the features of the system is a home entertainment system.

In typical home theaters, speakers are placed at fixed points in a room around a television or entertainment center. However in many places in the room, the fidelity changes and in one area the sound is better than the others. This is known as the “sweet spot.” The “sweet spot” is the optimal place for sound in a space.

In this system, the “sweet spot” of the sound system is controlled relative to a remote control that emits an ultrasonic tone that sensors receive, process, and react to. This ultrasonic tone is a three-dimensional event that occurs and is collected and processed by sensors in the room. In this system, the speakers react by adjusting themselves to create the “sweet spot.” In terms of the algorithm, the “sweet spot” is known as the epicenter of the wave forms being created by the speakers.

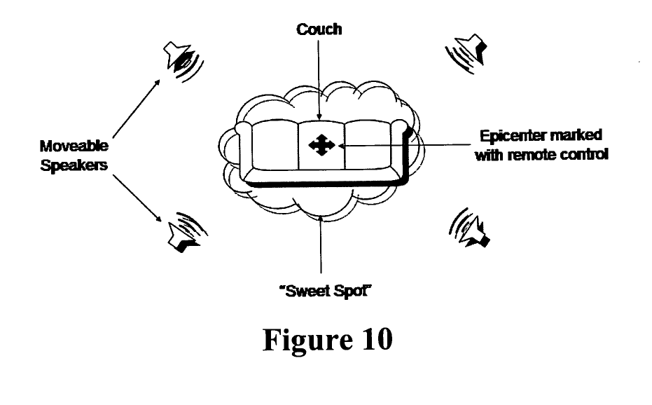

FIG. 10 is the layout of the home theater system indication the movable or adjustable speakers and labeling the “sweet spot.”

A further advancement of this system is to encode movements of sound relative to the “sweet spot” on entertainment media to fully recreate sound more accurately. For example, as an airplane flies overhead on a movie, the sound would be created by speakers that are moving and recreating the sound. This provides the listener an accurate recreation of the original sound.

Future Applications and Proposed Systems

Acoustic positioning for Training, Simulation, and Gaming

Utilize the concept of acoustic positioning to recreate environmental sound for training, simulation, and gaming purposes to provided enhanced realism to reinforce the objectives for training, simulation systems, and gaming.

Acoustic Surveillance and Tracking

As shown in FIG. 9, the system is capable of tracking an event. This can be used injunction with existing surveillance systems to add another layer of protection while using acoustic information. This has also been explored as a shoreline defense system to detect illegal entry using hydrophones as the sensor.

Fiber Optical Component Alignment

One severe cost of optical systems is the tuning and alignment of components. Utilizing the three-dimensional properties of the system, allows for auto alignment capabilities by monitoring how light generated from lasers is incident to sensors.

Free Space Optical Component Alignment

In free space optic systems, the orientation and position of the lasers and receivers need to be precise to remain at maximum efficiency. This system could allow for auto alignment and afford the ability to change the position as needed in the event of an obstruction or environmental concern.

Wireless Transmission Path Optimization

In directional based wireless communication systems, alignment of the receiver and transmitter are critical. The goal of this system would be to provide auto alignment of these components to maintain an optimized communication path.

Seismic Event Tracking (Earthquake, Volcano, Etc.)

Since this system requires five seismic sensors to determine the epicenter and hypocenter of a seismic event such as an earthquake and volcano eruption, the system allows for improved accuracy and provides a better understanding of historical data already collected.

Lighting Strike Detection

When lighting strikes an acoustic event occurs. Using a condenser array like the one in FIG. 6, the location of the lightning strike is determined.

Ordnance Detonation Detection

Since ordnance detonation causes seismic activity, the system is able to determine the location of such an event.

Positioning and Discovery of Dynamic Node Networks

Since sensors can be deployed wirelessly, their location can always be changing. For such a system to be effective, thee sensor's location and position relative to each other needs to be determined to provide increased accuracy of tracking systems consisting of non-tethered nodes.

Cetacean Tracking

Deploying high-powered sonar systems bring attention to the safety of cetaceans. This system can passively track cetaceans that vocalize to protect them from existing and future high-power, active systems.

Acoustic Profiling, Vibration Analysis, and Physical Medium Characterization

Using vibrations against an object will reveal weaknesses. A modified system to process vibrations collected by sensors could indicate the characterizations of the particular medium. An extension of this is acoustic profiling which takes into account the detailed information this system generates. This information could be used in designing home theater spaces and studios.

Dynamic Suspension System for Vehicles

The tires surrounding the driver of an automobile cause vibrations and increased environmental noise. If the driver of the automobile sat at the epicenter of the vibrations, this would be the optimum place to experience less noise and vibration. A dynamic suspensions system could be created reacting to the processing of the vibrations caused by the tires.

Visual Representation of Auditory Sensory Information for the Hearing Impaired

Hearing capable people can react to a sound or event when it happens by looking in that direction. This is a reaction that is missed by the hearing impaired and can be provided by a visual queue generated by a system using a very small sensor array passively monitoring its surroundings.

Relative Audio Representation of Object Position for the Visually Impaired

As a visually impaired person walks toward an object, the system provides a tone or biofeedback to indicate the relative position of the object. This could provide added safety and better navigation.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. An event position system comprising:
at least three sensors, wherein each of the at least three sensors is capable of detecting an event and creating data as an event is detected, and the relative position of each of the at least three sensors is known;
a real-time data collector, for collecting and storing data from the at least three sensors and the time at which such data occurs; and
a data processor, for determining the position of an event based on the event frequency, the time delay between detection of the event at each of the at least three sensors, and the position of each of the at least three sensors.

2. An event position detection method, comprising:
positioning at least two sensors in a medium;
determining the relative position of the at least two sensors;
monitoring the at least two sensors for the occurrence of an event;
recording the precise time at which the event is detected by each of the at least two sensors;
calculating the distance a waveform created by the event has traveled based the time difference between event detection at each of the at least two sensors and the propagation speed of the waveforms in the medium;
determining the event position based on the waveform travel distance for each of the at least two sensors.

3. The event position detection method of claim 2, further comprising performing error correction algorithms.

4. The event position detection method of claim 2, further comprising adjusting the event position based on media characteristic changes along the determined path to the epicenter.
